(19) United States
(12) Patent Application Publication
(10) Pub. No.: US 2008/0139048 A1
(43) Pub. Date: Jun. 12, 2008

(54) Connector and housing thereof

(75) Inventors: Yu-Yuan Tai, Taoyuan Hsien (TW); Zhao-Wei Guan, Taoyuan Hsien (TW); Yun Zuo, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/905,286

(22) Filed: Sep. 28, 2007

(30) Foreign Application Priority Data
Dec. 8, 2006 (TW) 095145993

(51) Int. Cl. H01R 13/648

(52) U.S. Cl. 439/607

(57) ABSTRACT

A connector includes a circuit board and a housing. The housing has a body and a ground element, wherein the ground element is connected with the body and is disposed with respect to the circuit board. The ground element is in electrical contact with a ground end of the circuit board by clipping or hooking. The ground element and the body are integrally formed as a single piece, and the ground element is elastically deformable.

### CROSS REFERENCE TO RELATED APPLICATIONS

This Non-provisional application claims priority under 35 U.S.C. §119(a) on Patent Application No(s). 095145993, filed in Taiwan, Republic of China on Dec. 8, 2006, the entire contents of which are hereby incorporated by reference.

### BACKGROUND OF THE INVENTION

1. Field of Invention

The present invention relates to a connector and the housing thereof. In particular, it relates to a connector and its housing without grounding by soldering.

2. Related Art

With rapid development in information technology, computers have become very popular. By using the network technology, people can quickly obtain the required information from the Internet or provide various information services to others. Therefore, it has become a trend of the information era to connect computers or peripheral devices to the network.

In general, people use a connector to connect the network with related electronic devices. As shown in FIG. 1, a conventional connector 1 includes a connecting base 10, a circuit board 11, such as a printed circuit board (PCB), and a metal housing 12. The metal housing 12 covers the connecting base 10 and the PCB 11. The connecting base 10 has an RJ (registered jack) connecting hole 101 or a USB (universal serial bus) connecting hole 102. The connecting holes 101, 102 are embedded with several terminals 103. The bottom of the connecting base 10 has several pins 104 and is disposed in the metal housing 12. Each terminal 103 is connected to a connecting point 111 on the PCB 11. By using the circuit on the PCB 11, each terminal 103 is electrically connected with the corresponding pin 104. When the plug of the connecting line is coupled with the connecting holes 101, 102 of the connector 1, the received network signals can be transmitted or received via the terminals 103 and the pins 104.

The connector 1 uses the metal housing 12 to protect the connecting base 10 and prevent electromagnetic interference (EMI). In addition to using the metal housing 12 to suppress external EMI, traditionally a ground wire 13 or a metal sheet (not shown) is necessary to apply for connection of the PCB 11 and the metal housing 12. That is, one end of the ground wire 13 is soldered onto the PCB 11, and the other end is soldered onto the metal housing 12. Such a grounding mechanism prevents the electromagnetic waves produced by the electronic devices on the PCB 11 from affecting the action of the connector 1.

However, this method of using a ground wire 13 not only adds an additional component to the connector but also involves a longer and more complicated process due to soldering. Therefore, the manufacturing cost of the connector is inevitably higher. Also, once the PCB is damaged and needs to be replaced, the ground wire 13, being soldered onto the metal housing, causes additional troubles for replacement.

### SUMMARY OF THE INVENTION

In view of the foregoing, the present invention is to provide a connector, which is manufactured without a soldering process and has lower cost, and a housing thereof.

To achieve the above, the present invention discloses a connector housing, which is electrically connected to a ground end of a circuit board, such as a PCB. The connector housing includes a body and a ground element. The ground element is connected with the body and is disposed with respect to the circuit board, wherein the ground element is in electrical contact with the ground end of the circuit board.

To achieve the above, the present invention also discloses a connector including a circuit board, such as a PCB, and a housing. The circuit board has a ground end, and the a housing includes a body and a ground element, wherein the ground element is connected with the body, disposed with respect to the circuit board, and in electrical contact with the ground end of the circuit board.

As mentioned above, a ground element is formed on the body of the housing of a connector of the present invention. The ground element of the housing is disposed with respect to the PCB and is electrically connected with the ground end of the PCB by clipping or hooking, so that no soldering is involved. In comparison with the prior art, the present invention has a direct contact between the ground element of the housing and the PCB, so that the soldering process and related equipments are not necessary. Therefore, the manufacturing process is simplified and the production time is shortened. Moreover, the ground element of the present invention can be formed just by bending a part of the body of the housing. When the PCB is assembled into the housing of the connector, it only needs to have one simply touch between the body of the housing and the ground element of the PCB, there is no soldering process to be performed. Also, once the PCB is damaged and needs to be replaced, it can be directly disassembled without difficulty so as to have advantages of easy replacing and flexibility.

### BRIEF DESCRIPTION OF THE DRAWINGS

The present invention will become more fully understood from the detailed description given herein below illustration only, and thus is not limitative of the present invention, and wherein:

FIG. 1 is a schematic view of a conventional connector;

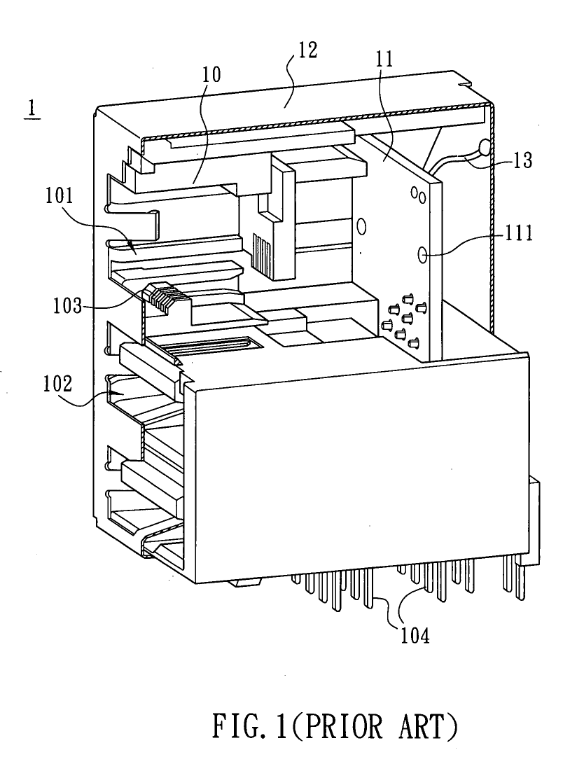

FIG. 2 is a schematic view of the connector according to an embodiment of the present invention;

FIG. 3 is a schematic view showing the interior of the connector in FIG. 2; and

FIG. 4 is a part view showing the interior of another connector according to the embodiment of the present invention.

### DETAILED DESCRIPTION OF THE INVENTION

The present invention will be apparent from the following detailed description, which proceeds with reference to the accompanying drawings, wherein the same references relate to the same elements.

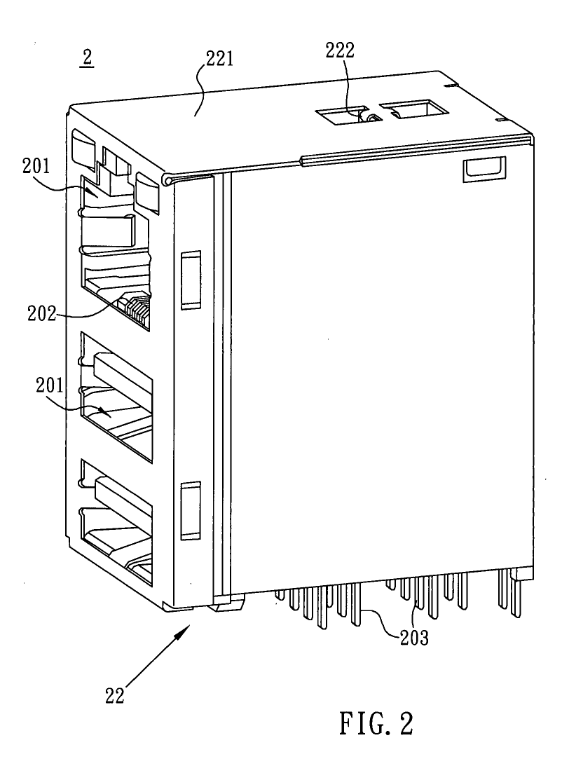

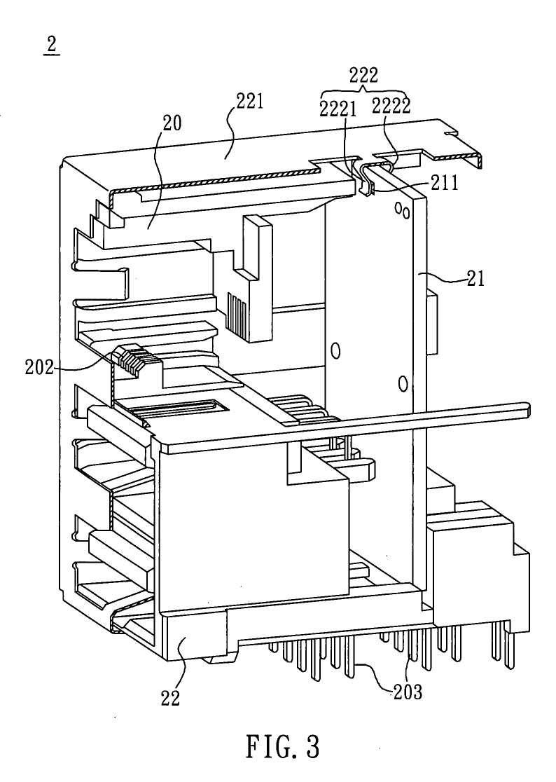

Referring both to FIGS. 2 and 3. According to an embodiment of the present invention, a connector 2 includes a connecting base 20, a circuit board 21, such as a printed circuit board (PCB), and a housing 22.

The connecting base 20 has at least one container 201 with several terminals 202 embedded therein. The container 201 is a connecting hole satisfying the RJ-11, RJ-12, RJ-45, or USB specification. The connecting base 20 may have several containers 201, with some combination of the RJ-11, RJ-12, RJ-45, and USB connecting holes. The connector 2 in this embodiment has an RJ-45 connecting hole and two USB connecting holes.

The connecting base 20 further has several pins 203. The terminals 202 are electrically connected to corresponding pins 20 via the PCB 21 in order to communicate with external signals. In this embodiment, the PCB 21 has a ground end 211, which is formed as at least a pad on the PCB 21 for grounding. The material of the pad is an electricity conductive material, such as a metal.

The housing 22 covers the connecting base 20 and the PCB 21. The housing 22 has a body 221 and a ground element 222. The ground element 222 is connected with the body 221 disposed with respect to the PCB 21. The ground element 222 is electrically connected with the ground end 211 (e.g., pad) of the circuit board 21. In this embodiment, the ground element 222 can be integrally formed with the body 221 as a single piece, and the ground element 222 can be formed by bending a part of the body 221 as a ground part thereof. However, the present invention is not limited by this example. The ground element 222 and the body 221 can be separate components, and further the ground element 222 and the body 221 are connected by soldering, welding, or wedging. The material of the ground element 222 or the body is an electricity conductive material, such as a metal or alloy.

In the embodiment, the ground element 222 is electrically coupled with the ground end 211 of the PCB 21 by clipping. The ground element 222 is a clipper with a first clip arm 2221 and a second clip arm 2222 for respectively clipping two opposite sides of the PCB 21, and the first clip arm 2221 and the second clip arm 2222 are in electrical contact with the ground end of the PCB 21. Moreover, the ground element 222 is elastically deformable and it can have flexibility to hold various kind of PCB with different thicknesses. Nevertheless, the electrical connection between the ground element 222 and the PCB 21 is not limited to such clipping way, as described above. Alternatively, the ground element 222 can have a hook portion (not shown) which electrically contacts with the ground end 211 of the PCB 21 by hooking.

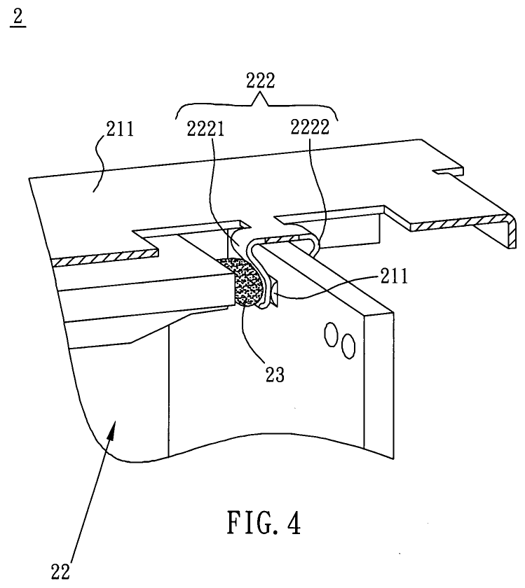

Please refer to FIG. 4, which is a part view showing the interior of another connector according to the embodiment of the present invention. In addition to the connector 2 shown in FIG. 2, the connector 2 further includes a pressing element 23 for enhancing a connection between the ground element 222 of the connector housing 20 and the ground end 211 of the PCB 21. The pressing element 23 is disposed in the vicinity of the ground element 222 and is in contact with the ground element 222 so that the pressing element 23 provides a force to have a better electrical connection between the ground element 222 and the ground end 211. In this embodiment, the pressing element 23 is made of a non-conductive material such as plastics.

In summary, because the ground element of the present invention is formed on the body of the housing of the connector, and the ground element of the housing is disposed with respect to the PCB and is electrically connected with the ground end of the PCB by clipping or hooking, so that no soldering is involved. In comparison with the prior art, the present invention has a direct contact between the ground element of the housing and the PCB, so that the soldering process and related equipments are not necessary. Therefore, the manufacturing process is simplified and the production time is shortened. Moreover, the ground element of the present invention can be formed just by bending a part of the body of the housing. When the PCB is assembled into the housing of the connector, it only needs to have one simply touch between the body of the housing and the ground element of the PCB, there is no soldering process to be performed. Also, once the PCB is damaged and needs to be replaced, it can be directly disassembled without difficulty so as to have advantages of easy replacing and flexibility.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A connector housing, electrically connected to a ground end of a circuit board, the connector housing comprising:
a body; and
a ground element, which is connected with the body and is disposed with respect to the circuit board, wherein the ground element is in electrical contact with the ground end of the circuit board.

2. The connector housing of claim 1, wherein the ground element and the body are integrally formed as a single piece, and the ground element is a ground part of the body.

3. The connector housing of claim 1, wherein the ground element is connected with the body by soldering, welding or wedging.

4. The connector housing of claim 1, wherein the ground element is elastically deformable, and the ground element is in electrical contact with the ground end of the circuit board by clipping or hooking.

5. The connector housing of claim 4, wherein the ground element has a first clip arm and a second clip arm for respectively clipping two opposite sides of the circuit board, and the first clip arm and/or the second clip arm is in electrical contact with the ground end of the circuit board.

6. The connector housing of claim 4, wherein the ground element of the connector housing is a clipper, the ground end of the circuit board is a pad, and the clipper is disposed and positioned corresponding to the pad.

7. The connector housing of claim 4, wherein the ground element of the connector housing has a hook portion which electrically contacts with the ground end.

8. The connector housing of claim 4, further comprising a pressing element which is in contact with the ground element for enhancing a connection between the ground element of the connector housing and the ground end of the circuit board.

9. The connector housing of claim 8, wherein the pressing element comprises a non-conductive material, such as plastic.

10. The connector housing of claim 1, wherein the ground element or the body comprises an electricity conductive material, such as a metal or alloy.

11. A connector, comprising:
a circuit board, comprising a ground end; and
a housing, comprising a body and a ground element, wherein the ground element is connected with the body, disposed with respect to the circuit board, and in electrical contact with the ground end of the circuit board.

12. The connector of claim 11, wherein the ground element and the body are integrally formed as a single piece, and the ground element is a ground part of the body.

13. The connector of claim 11, wherein the ground element is connected with the body by soldering, welding or wedging.

14. The connector of claim 11, wherein the ground element is elastically deformable, and the ground element is in electrical contact with the ground end of the circuit board by clipping or hooking.

15. The connector of claim 14, wherein the ground element has a first clip arm and a second clip arm for respectively clipping two opposite sides of the circuit board, and the first clip arm and/or the second clip arm is in electrical contact with the ground end of the circuit board.

16. The connector of claim 14, wherein the ground element of the connector housing is a clipper, the ground end of the circuit board is a pad, and the clipper is disposed and positioned corresponding to the pad.

17. The connector of claim 14, wherein the ground element of the connector housing has a hook portion which electrically contacts with the ground end.

18. The connector of claim 14, further comprising a pressing element which is in contact with the ground element for enhancing a connection between the ground element of the connector housing and the ground end of the circuit board.

19. The connector of claim 18, wherein the pressing element comprises a non-conductive material, such as plastic.

20. The connector of claim 11, wherein the connector is an RJ-11 connector, an RJ-12 connector, an RJ-45 connector or an USB connector.
